(19) United States
(12) Patent Application Publication
(10) Pub. No.: US 2025/0197595 A1
(43) Pub. Date: Jun. 19, 2025

(54) RESIN COMPOSITION, MOLDING MATERIAL, AND MOLDED ARTICLE

(71) Applicant: JAPAN COMPOSITE CO., LTD., Tokyo (JP)

(72) Inventors: Ikuo AKAI, Shizuoka-shi, SHIZUOKA (JP); Masahiro HAKOTANI, Shizuoka-shi, SHIZUOKA (JP)

(21) Appl. No.: 18/847,065

(22) PCT Filed: Mar. 20, 2023
(86) PCT No.: PCT/JP2023/010896

§ 371 Date: Sep. 13, 2024

(30) Foreign Application Priority Data
Mar. 22, 2022 (JP) 2022-045234

(51) Int. Cl. C08K 3/04; C08K 5/3492; C08K 5/521

(52) U.S. Cl. CPC C08K 3/042; C08K 5/34924; C08K 5/521

(57) ABSTRACT

A resin composition includes a resin component, an aluminum hydroxide, expandable graphite, and a flame retardant. The flame retardant contains a phosphorus-containing flame retardant and a nitrogen-containing flame retardant. The expandable graphite content with respect to 100 parts by mass of the resin component, the phosphorus content of the phosphorus-containing flame retardant with respect to 100 parts by mass of the resin component, a mass ratio of the nitrogen content of the nitrogen-containing flame retardant to the phosphorous content of the phosphorous-containing flame retardant, and the mass ratio of the expandable graphite content to the phosphorus content of the phosphorus-containing flame retardant are within a predetermined range.

### TECHNICAL FIELD

The present invention relates to a resin composition, a molding material, and a molded article.

### BACKGROUND ART

Conventionally, a molded article made of a molding material (above all, a sheet molding compound (SMC)) containing a resin component (for example, an unsaturated polyester resin) has, in particular, excellent appearance, mechanical properties, water resistance, and corrosion resistance, and has been used in a wide range of fields.

Further, as such a molding material, for example, a thermoplastic polyester resin composition containing a thermoplastic polyester resin, a phosphorus-based flame retardant, and a nitrogen-based flame retardant has been proposed (ref: for example, Patent Document 1).

### CITATION LIST

### Patent Document

Patent Document 1: Japanese Unexamined Patent Publication No. 2021-14478

### SUMMARY OF THE INVENTION

### Problem to be Solved by the Invention

Recently, a large-capacity cell is mounted in an automobile with electrification, and resinification of a vessel (battery case) in which the cell is stored for a weight reduction has been promoted. Such a resin is required to have further more excellent heat insulation properties in order to prevent the spread of vehicle fires.

In addition, when a molded article is produced using a resin composition, moldability is required.

The present invention provides a resin composition for producing a molded article having excellent heat insulation properties and moldability, a molding material for producing the molded article having the excellent heat insulation properties and moldability, and the molded article having the excellent heat insulation properties and moldability.

### Means for Solving the Problem

The present invention [1] includes a resin composition including a resin component, an aluminum hydroxide, expandable graphite, and a flame retardant, wherein the flame retardant contains a phosphorus-containing flame retardant and a nitrogen-containing flame retardant; the expandable graphite content is 1.0 part by mass or more and below 5.0 parts by mass with respect to 100 parts by mass of the resin component; the phosphorus content of the phosphorus-containing flame retardant is 1.5 parts by mass or more and 4.5 parts by mass or less with respect to 100 parts by mass of the resin component; a mass ratio of the nitrogen content of the nitrogen-containing flame retardant with respect to 100 parts by mass of the resin component to the phosphorus content of the phosphorus-containing flame retardant with respect to 100 parts by mass of the resin component is 0.5 or more and 3.0 or less; and the mass ratio of the expandable graphite content with respect to 100 parts by mass of the resin component to the phosphorus content of the phosphorus-containing flame retardant with respect to 100 parts by mass of the resin component is 0.5 or more and 2.0 or less.

The present invention [2] includes the resin composition described in the above-described [1], wherein the nitrogen content of the nitrogen-containing flame retardant is 2.0 parts by mass or more and 3.0 parts by mass or less with respect to 100 parts by mass of the resin component.

The present invention [3] includes a molding material including the resin composition described in any one of the above-described [1] or [2] and a reinforcing fiber.

The present invention [4] includes a molded article including a cured product of the molding material described in the above-described [3].

### EFFECT OF THE INVENTION

The resin composition of the present invention includes the expandable graphite and the flame retardant, and contains, as the flame retardant, the phosphorus-containing flame retardant and the nitrogen-containing flame retardant. Then, in the resin composition, the expandable graphite content, the phosphorus content of the phosphorus-containing flame retardant, the mass ratio of the nitrogen content of the nitrogen-containing flame retardant to the phosphorous content of the phosphorous-containing flame retardant, and the mass ratio of the expandable graphite content to the phosphorus content of the phosphorus-containing flame retardant are within a predetermined range. Therefore, it is possible to produce the molded article having excellent heat insulation properties and moldability.

The molding material of the present invention includes the resin composition of the present invention. Therefore, it is possible to produce the molded article having the excellent heat insulation properties and moldability.

The molded article of the present invention includes the cured product of the molding material of the present invention. Therefore, it has the excellent heat insulation properties and moldability.

### DESCRIPTION OF EMBODIMENTS

A resin composition of the present invention includes a resin component, an aluminum hydroxide, expandable graphite, and a flame retardant.

### Resin Component

The resin component contains a radically polymerizable resin.

### [Radically Polymerizable Resin]

Examples of the radically polymerizable resin include unsaturated polyester resins, vinyl ester resins, and urethane (meth)acrylates. As the radically polymerizable resin, from the viewpoint of excellent various properties (toughness, strength, durability, weather resistance, hot water resistance, and transparency), preferably, an unsaturated polyester resin and a vinyl ester resin are used.

The unsaturated polyester resin contains an unsaturated polyester and a polymerizable monomer. In other words, the unsaturated polyester resin is an unsaturated polyester resin composition containing the unsaturated polyester and the polymerizable monomer.

The unsaturated polyester is a condensation product of a polybasic acid and a polyhydric alcohol.

The polybasic acid includes the polybasic acid having an ethylenically unsaturated double bond (hereinafter, referred to as an ethylenically unsaturated bond-containing polybasic acid) as an essential component, and the polybasic acid without having the ethylenically unsaturated double bond (hereinafter, referred to as an ethylenically unsaturated bond-free polybasic acid) as an arbitrary component.

Examples of the ethylenically unsaturated bond-containing polybasic acid include ethylenically unsaturated aliphatic dibasic acids and anhydrides thereof, halides of ethylenically unsaturated aliphatic dibasic acids, and alkyl esters of ethylenically unsaturated aliphatic dibasic acids.

Examples of the ethylenically unsaturated aliphatic dibasic acid include maleic acid, fumaric acid, itaconic acid, and dihydromuconic acid. Further, the ethylenically unsaturated bond-containing polybasic acid includes, for example, an acid anhydride derived from the above-described ethylenically unsaturated aliphatic dibasic acid. Examples of the acid anhydride derived from the ethylenically unsaturated aliphatic dibasic acid include maleic anhydrides. As the ethylenically unsaturated bond-containing polybasic acid, preferably, a maleic anhydride is used.

Examples of the ethylenically unsaturated bond-free polybasic acid include saturated aliphatic polybasic acids, saturated alicyclic polybasic acids, aromatic polybasic acids, anhydrides of these acids, halides of these acids, and alkyl esters of these acids.

Examples of the saturated aliphatic polybasic acid include saturated aliphatic dibasic acids.

Examples of the saturated aliphatic dibasic acid include oxalic acid, malonic acid, succinic acid, methylsuccinic acid, 2,2-dimethylsuccinic acid, 2,3-dimethylsuccinic acid, hexylsuccinic acid, glutaric acid, 2-methylglutaric acid, 3-methylglutaric acid, 2,2-dimethylglutaric acid, 3,3-dimethylsuccinic acid, adipic acid, pimelic acid, suberic acid, azelaic acid, and sebacic acid. Further, examples of the saturated aliphatic polybasic acid also include acid anhydrides derived from the above-described saturated aliphatic dibasic acids. Examples of the acid anhydride derived from the saturated aliphatic dibasic acid include oxalic acid anhydride and succinic anhydride.

Examples of the saturated alicyclic polybasic acid include saturated alicyclic dibasic acids.

Examples of the saturated alicyclic dibasic acid include HET acid, 1,2-hexahydrophthalic acid, 1,1-cyclobutanedicarboxylic acid, and 1,4-cyclohexanedicarboxylic acid (cis- or trans-1,4-cyclohexanedicarboxylic acid or a mixture thereof). The saturated alicyclic polybasic acid includes the acid anhydride derived from the above-described saturated alicyclic dibasic acid. Examples of the acid anhydride derived from the saturated alicyclic dibasic acid include HET acid anhydrides.

Examples of the aromatic polybasic acid include aromatic dibasic acids.

Examples of the aromatic dibasic acid include phthalic acid (orthophthalic acid, isophthalic acid, terephthalic acid), trimellitic acid, and pyromellitic acid. Further, examples of the aromatic polybasic acid include acid anhydrides derived from the above-described aromatic dibasic acids. Examples of the acid anhydride derived from the aromatic dibasic acid include phthalic acid anhydrides. As the aromatic dibasic acid, preferably, an isophthalic acid is used.

Examples of the ethylenically unsaturated bond-free polybasic acid include aromatic polybasic acids.

These polybasic acids may be used alone or in combination of two or more.

When the polybasic acid contains the ethylenically unsaturated bond-containing polybasic acid and the ethylenically unsaturated bond-free polybasic acid, a mixing ratio of the ethylenically unsaturated bond-containing polybasic acid is, for example, 20 mol % or more, preferably 50 mol % or more with respect to 100 mol of the total polybasic acids.

Examples of the polyhydric alcohol include dihydric alcohols and trihydric alcohols.

Examples of the dihydric alcohol include aliphatic diols, alicyclic diols, and aromatic diols. Examples of the aliphatic diol include alkane diols and ether diols. Examples of the alkane diol include ethylene glycol, propylene glycol (1,2- or 1,3-propanediol or a mixture thereof), butylene glycol (1,2- or 1,3-or 1,4-butylene glycol or a mixture thereof), 1,5-pentanediol, 1,6-hexanediol, neopentyl glycol, 2-methyl-1,3-propanediol, 2-butyl-2-ethyl-1,3-propanediol, 3-methyl-1,5-pentanediol, 2,2,2-trimethylpentanediol, and 3,3-dimethylolheptane. Examples of the ether diol include diethylene glycol, triethylene glycol, and dipropylene glycol. Examples of the alicyclic diol include cyclohexanediol (1,2- or 1,3- or 1,4-cyclohexanediol or a mixture thereof), cyclohexanedimethanol (1,2- or 1,3- or 1,4-cyclohexanedimethanol or a mixture thereof), cyclohexanediethanol (1,2- or 1,3- or 1,4-cyclohexanediethanol or a mixture thereof), and hydrogenated bisphenol A. Examples of the aromatic diol include ethylene oxide adducts of bisphenol A and propylene oxide adducts of bisphenol A.

Examples of the trihydric alcohol include glycerin, trimethylolpropane, and triisopropanolamine.

As the polyhydric alcohol, preferably, a dihydric alcohol is used. As the polyhydric alcohol, more preferably, an aliphatic diol is used. As the polyhydric alcohol, further more preferably, an alkane diol is used. As the polyhydric alcohol, particularly preferably, a propylene glycol and a neopentyl glycol are used.

These polyhydric alcohols may be used alone or in combination of two or more.

The unsaturated polyester is obtained by polycondensation of the polybasic acid and the polyhydric alcohol.

In order to polycondense the polybasic acid and the polyhydric alcohol, first, the polybasic acid and the polyhydric alcohol are blended at the following equivalent ratio.

An equivalent ratio of the polyhydric alcohol to the polybasic acid (hydroxyl group of the polyhydric alcohol/carboxyl group of the polybasic acid) is, for example, 0.9 or more, preferably 0.95 or more, and for example, 1.2 or less, preferably 1.1 or less.

After the polybasic acid and the polyhydric alcohol are blended, the polybasic acid and the polyhydric alcohol are reacted by stirring under normal pressure and a nitrogen atmosphere. A reaction temperature is, for example, 150° C. or more, preferably 190° C. or more, and for example, 250° C. or less, preferably 230° C. or less.

In the above-described reaction, a known solvent and a known reaction catalyst may be also blended as needed.

Thus, the unsaturated polyester is obtained.

An acid value of the unsaturated polyester (measurement method: in conformity with JIS K6901 (2008)) is, for example, 5 mgKOH/g or more, preferably 10 mgKOH/g or more, and for example, below 40 mgKOH/g, preferably 30 mgKOH/g or less.

A weight average molecular weight of the unsaturated polyester is, for example, 2000 or more, preferably 4000 or more, and for example, 25000 or less, preferably 20000 or less.

The weight average molecular weight is the weight average molecular weight by GPC (gel permeation chromatography) in terms of polystyrene. The weight average molecular weight can be determined by GPC measurement of the unsaturated polyester.

Examples of the polymerizable monomer include styrene-based monomers and (meth)acrylate-based monomers.

Examples of the styrene-based monomer include styrene, vinyltoluene, t-butylstyrene, and chlorostyrene.

Examples of the (meth)acrylate-based monomer include alkyl (meth)acrylate, allyl (meth)acrylate, ring structure-containing (meth)acrylate, hydroxyalkyl (meth)acrylate, alkoxyalkyl (meth)acrylate, aminoalkyl (meth)acrylate, fluoroalkyl (meth)acrylate, and polyfunctional (meth)acrylate. Examples of the alkyl (meth)acrylate include methyl (meth)acrylate, ethyl (meth)acrylate, isopropyl (meth)acrylate, butyl (meth)acrylate, n-butyl (meth)acrylate, t-butyl (meth)acrylate, isobutyl (meth)acrylate, 2-ethylhexyl (meth)acrylate, lauryl (meth)acrylate, tridecyl (meth)acrylate, and stearyl (meth)acrylate. An example of the allyl (meth)acrylate includes allyl (meth)acrylate. Examples of the ring structure-containing (meth)acrylate include cyclohexyl (meth)acrylate, benzyl (meth)acrylate, isobornyl (meth)acrylate, glycidyl (meth)acrylate, tetrahydrofurfuryl (meth)acrylate, dicyclopentenyl (meth)acrylate, dicyclopentanyl (meth)acrylate, and dicyclopentenyloxyethyl (meth)acrylate. Examples of the hydroxyalkyl (meth)acrylate include 2-hydroxyethyl (meth)acrylate and 2-hydroxypropyl (meth)acrylate. Examples of the alkoxyalkyl (meth)acrylate include 2-methoxyethyl (meth)acrylate and 2-ethoxyethyl (meth)acrylate. Examples of the aminoalkyl (meth)acrylate include dimethylaminoethyl (meth)acrylate, diethylaminoethyl (meth)acrylate, and chloride salts of these. Examples of the fluoroalkyl (meth)acrylate include trifluoroethyl (meth)acrylate and heptadecafluorodecyl (meth)acrylate. Examples of the polyfunctional (meth)acrylate include ethylene glycol di(meth)acrylate, diethylene glycol di(meth) acrylate, trimethylolpropane tri(meth)acrylate, pentaerythritol tetra(meth)acrylate, and dipentaerythritol hexa(meth)acrylate.

As the polymerizable monomer, preferably, a styrene-based monomer is used, more preferably, styrene is used.

These polymerizable monomers may be used alone or in combination of two or more.

Then, the above-described unsaturated polyester is dissolved in the polymerizable monomer (preferably, the styrene), and if necessary, an additive (polymerization inhibitor (described later) (preferably, a hydroquinone)) is blended thereto, thereby preparing the unsaturated polyester resin.

In preparation of the unsaturated polyester resin, the mixing ratio of the polymerizable monomer is, for example, 50 parts by mass or more, preferably 60 parts by mass or more, and for example, 100 parts by mass or less with respect to 100 parts by mass of the unsaturated polyester. Further, the mixing ratio of the polymerization inhibitor is, for example, 0.001 parts by mass or more, preferably 0.005 parts by mass or more, and for example, 0.1 parts by mass or less, preferably 0.05 parts by mass or less with respect to 100 parts by mass of the unsaturated polyester.

Further, after the unsaturated polyester resin is prepared, when the unsaturated polyester resin is mixed with another component (vinyl ester resin, low shrinkage agent (described later), aluminum hydroxide, expandable graphite, flame retardant, and additive (described later)), it is possible to further blend the polymerizable monomer thereto.

The vinyl ester resin contains a vinyl ester and the polymerizable monomer. In other words, the vinyl ester resin is a vinyl ester resin composition containing the vinyl ester and the polymerizable monomer.

The vinyl ester is a reaction product of the epoxy resin and an unsaturated monobasic acid.

Examples of the epoxy resin include bisphenol-type epoxy resins and novolac-type epoxy resins. As the epoxy resin, preferably, a bisphenol-type epoxy resin is used.

The bisphenol-type epoxy resin is, for example, a reaction product of a phenol component and an epoxy component. Examples of the phenol component include bisphenol compounds (for example, bisphenol A). Examples of the epoxy component include bisphenol A-type epoxy compounds.

Then, in order to obtain the bisphenol-type epoxy resin, the phenol component and the epoxy component are reacted. Specifically, the phenol component and the epoxy component are blended, and these are reacted.

In the above-described reaction, the mixing ratio of the epoxy component is, for example, 1.5 equivalents or more, preferably 2.0 equivalents or more, more preferably 3.0 equivalents or more, and for example, 5.0 equivalents or less, preferably 4.0 equivalents or less with respect to 1 equivalent of the phenol component.

In addition, in the above-described reaction, a catalyst may be also added as needed.

Examples of the catalyst include amines, quaternary ammonium salts, imidazoles, and phosphines. Examples of the amines include triethylamine and benzyldimethylamine. Examples of the quaternary ammonium salt include tetramethylammonium chloride and triethylbenzylammonium chloride. An example of the imidazoles includes 2-ethyl-4-imidazole. An example of the phosphines includes triphenylphosphine.

As the catalyst, preferably, a quaternary ammonium salt is used, more preferably, a triethylbenzylammonium chloride is used.

These catalysts may be used alone or in combination of two or more.

The mixing ratio of the catalyst is, for example, 0.01 parts by mass or more, and for example, 1.0 part by mass or less, preferably 0.1 parts by mass or less with respect to 100 parts by mass of the total amount of the phenol component and the epoxy component.

In addition, in the above-described reaction, the reaction is carried out under the presence of an inert gas, and the reaction temperature is, for example, 100° C. or more, preferably 130° C. or more, and for example, 180° C. or less.

Thus, the bisphenol-type epoxy resin is obtained.

An epoxy equivalent of the bisphenol-type epoxy resin is, for example, 150 g/eq or more, preferably 250 g/eq or more, and for example, 800 g/eq or less, preferably 400 g/eq or less, more preferably 350 g/eq or less.

When the bisphenol-type epoxy resins are used in combination of two, the above-described epoxy equivalent is the epoxy equivalent of the total bisphenol-type epoxy resins obtained by multiplying the epoxy equivalent of each bisphenol-type epoxy resin by the mass ratio of each bisphenol-type epoxy resin to the total amount of the bisphenol-type epoxy resin, and by summing up them together.

Further, as the epoxy resin, a commercially available product may be also used.

Examples of the unsaturated monobasic acid include monocarboxylic acids, and a reaction product of the dibasic acid anhydride and an alcohol having at least one unsaturated group in a molecule.

Examples of the monocarboxylic acid include (meth)acrylate, crotonic acid, cinnamic acid, and sorbic acid. The (meth)acryl is the same as methacryl and/or acryl.

Examples of the dibasic acid anhydride include maleic anhydride, succinic anhydride, phthalic anhydride, tetrahydro phthalic anhydride, and hexahydro phthalic anhydride. Examples of the alcohol having an unsaturated group include hydroxyethyl (meth)acrylate, hydroxypropyl (meth)acrylate, hydroxybutyl (meth)acrylate, pentaerythritol tri(meth)acrylate, and glycerin di(meth)acrylate.

As the unsaturated monobasic acid, preferably, a monocarboxylic acid is used, more preferably, a (meth)acrylate is used, further more preferably, a methacrylic acid is used.

These unsaturated monobasic acids may be used alone or in combination of two or more.

In a reaction of the epoxy resin and the unsaturated monobasic acid, an epoxy group of the epoxy resin and the unsaturated monobasic acid are subjected to an addition reaction.

In addition, in the above-described reaction, an equivalent of a carboxyl group of the unsaturated monobasic acid to the epoxy group of the epoxy resin is, for example, 0.8 or more, preferably 1.0 or more, and for example, 1.5 or less, preferably 1.2 or less.

In addition, in the above-described reaction, the catalyst may be added as needed.

An example of the catalyst includes the same catalyst as the one used in the reaction of the phenol component with the epoxy component described above. As the catalyst, preferably, a quaternary ammonium salt is used, more preferably, a triethylbenzylammonium chloride is used.

The mixing ratio of the catalyst is, for example, 0.01 parts by mass or more, preferably 0.05 parts by mass or more, and for example, 1.0 part by mass or less, preferably 0.6 parts by mass or less with respect to 100 parts by mass of the epoxy resin.

In addition, in the above-described reaction, a polymerization inhibitor (described later) (preferably, the hydroquinone) may be added as needed.

The mixing ratio of the polymerization inhibitor is, for example, 0.001 parts by mass or more, preferably 0.05 parts by mass or more, and for example, 0.5 parts by mass or less, preferably 0.1 parts by mass or less with respect to 100 parts by mass of the epoxy resin.

In addition, in the above-described reaction, the reaction is carried out under the presence of oxygen, and the reaction temperature is, for example, 80° C. or more, preferably 100° C. or more, and for example, 150° C. or less, preferably 130° C. or less.

The above-described reaction can be also carried out following the reaction of the phenol component and the epoxy component described above.

Thus, the vinyl ester is obtained.

The acid value of the vinyl ester (measurement method: in conformity with JIS K6901 (2008)) can be determined from a charging ratio of the epoxy resin and the unsaturated monobasic acid. For example, the acid value thereof is 1 mgKOH/g or more, and for example, 20 mgKOH/g or less, preferably 10 mgKOH/g or less.

Examples of the polymerizable monomer include polymerizable monomers illustrated in the unsaturated polyester resin, and preferably, a styrene-based monomer is used, more preferably, styrene is used.

Then, the vinyl ester resin is prepared by dissolving the vinyl ester in the polymerizable monomer. In the preparation of the vinyl ester resin, the mixing ratio of the polymerizable monomer is, for example, 50 parts by mass or more, preferably 60 parts by mass or more, and for example, 80 parts by mass or less with respect to 100 parts by mass of the vinyl ester.

Further, after the vinyl ester resin is prepared, when the vinyl ester resin is mixed with the other component (unsaturated polyester resin, low shrinkage agent (described later), aluminum hydroxide, expandable graphite, flame retardant, and additive (described later)), it is also possible to further blend the polymerizable monomer thereto.

These radically polymerizable resins may be used alone or in combination of two or more, and preferably, an unsaturated polyester resin and a vinyl ester resin are used in combination. When the unsaturated polyester resin and the vinyl ester resin are used in combination, the mixing ratio of the unsaturated polyester is, for example, 70 parts by mass or more, preferably 80 parts by mass or more, and for example, 90 parts by mass or less with respect to 100 parts by mass of the total amount of the unsaturated polyester and the vinyl ester. Further, the mixing ratio of the vinyl ester is, for example, 10 parts by mass or more, and for example, 30 parts by mass or less, preferably 20 parts by mass or less.

The mixing ratio of the radically polymerizable resin is, for example, 40 parts by mass or more, preferably 55 parts by mass or more, and for example, 80 parts by mass or less, preferably 70 parts by mass or less with respect to 100 parts by mass of the resin component.

### [Low Shrinkage Agent]

The resin component preferably contains the low shrinkage agent.

Examples of the low shrinkage agent include polyethylene, polystyrene, styrene-based thermoplastic elastomers, cross-linked polystyrene, polyvinyl acetate-polystyrene block copolymers, polyvinyl acetate, polymethyl methacrylate, and saturated polyester resins. As the low shrinkage agent, preferably, a polyethylene, a polystyrene, a styrene-based thermoplastic elastomer, a polyvinyl acetate, and a saturated polyester resin are used.

Examples of the styrene-based thermoplastic elastomer include styrene-butadiene block copolymer elastomers, styrene-isoprene block copolymer elastomers, styrene-ethylene/butylene block copolymer elastomers, and styrene-ethylene/propylene block copolymer elastomers. As the styrene-based thermoplastic elastomer, preferably, a styrene-butadiene block copolymer elastomer is used.

Further, as the styrene-based thermoplastic elastomer, a commercially available product may be also used. Examples of the commercially available product include D1101, D1102, D1155, DKX405, DKX410, DKX415, D1192, D1161, D1171, G1651, G1652, G1654, G1701, and G1730 (hereinbefore, manufactured by KRATON CORPORATION); Asaprene T411, Asaprene T432, Tufprene A, Tufprene 125, Tufprene 126S, Tufprene 315, Tufprene 912, Tuftec H1141, Tuftec H1041, Tuftec H1043, and Tuftec H1052 (hereinbefore, manufactured by Asahi Kasei Corporation); and SEPTON 1001 and 1201 (hereinbefore, manufactured by KURARY CO., LTD.).

Further, the styrene content in the styrene-based thermoplastic elastomer is, for example, 5% by mass or more, and for example, 80% by mass or less.

The saturated polyester resin is obtained by dissolving a saturated polyester in the polymerizable monomer.

The saturated polyester is the polymerization product of the above-described ethylenically unsaturated bond-free polybasic acid and the above-described polyhydric alcohol.

As the ethylenically unsaturated bond-free polybasic acid, preferably, an adipic acid and an isophthalic acid are used.

As the polyhydric alcohol, preferably, a dihydric alcohol is used, more preferably, a neopentyl glycol is used.

The saturated polyester is obtained by subjecting the ethylenically unsaturated bond-free polybasic acid and the polyhydric alcohol to the polycondensation (condensation polymerization).

In order to polycondense (condensation polymerize) the ethylenically unsaturated bond-free polybasic acid with the polyhydric alcohol, the ethylenically unsaturated bond-free polybasic acid is blended with the polyhydric alcohol so that the equivalent ratio of the polyhydric alcohol to the polybasic acid (hydroxyl group of the polyhydric alcohol/carboxyl group of the polybasic acid) is, for example, 0.9 or more, preferably 0.95 or more, and for example, 1.2 or less, preferably 1.1 or less, and, the obtained mixture is stirred under the normal pressure and the nitrogen atmosphere.

The reaction temperature is, for example, 150° C. or more, preferably 190° C. or more, and for example, 250° C. or less, preferably 230° C. or less.

Reaction time is, for example, 8 hours or more, and for example, 30 hours or less.

In the above-described reaction, a known solvent and a known catalyst may be also blended as needed.

Thus, the saturated polyester is obtained.

The acid value of the saturated polyester (measurement method: in conformity with JIS K6901 (2008)) is, for example, 5 mgKOH/g or more, and for example, below 40 mgKOH/g.

Then, the saturated polyester is dissolved in the polymerizable monomer (preferably, the styrene), and if necessary, the additive (polymerization inhibitor (described later) (preferably, the hydroquinone)) is blended thereto, thereby preparing the saturated polyester resin.

In the preparation of the saturated polyester resin, the mixing ratio of the polymerizable monomer is, for example, 35 parts by mass or more, and for example, 150 parts by mass or less with respect to 100 parts by mass of the saturated polyester. Further, the mixing ratio of the polymerization inhibitor is, for example, 0.001 parts by mass or more, preferably 0.005 parts by mass or more, and for example, 0.1 parts by mass or less, preferably 0.05 parts by mass or less with respect to 100 parts by mass of the saturated polyester.

The number average molecular weight of the low shrinkage agent is, for example, 5000 or more, preferably 10000 or more, and for example, 200000 or less, preferably 100000 or less.

These low shrinkage agents may be used alone or in combination of two or more.

Further, by dissolving the low shrinkage agent in the polymerizable monomer, it is also possible to prepare a polymerizable monomer solution of the low shrinkage agent.

In the polymerizable monomer solution of the low shrinkage agent, the solid concentration of the low shrinkage agent is, for example, 20% by mass or more, and for example, 70% by mass or less.

The mixing ratio of the low shrinkage agent is, for example, 1 part by mass or more, preferably 5 parts by mass or more, and for example, 20 parts by mass or less with respect to 100 parts by mass of the resin component.

The resin component preferably contains the radically polymerizable resin and the low shrinkage agent. The resin component more preferably consists of the radically polymerizable resin and the low shrinkage agent.

### <Aluminum Hydroxide>

The aluminum hydroxide is blended so as to impart flame retardancy, and also to impart transparency and depth.

The mixing ratio of the aluminum hydroxide is 30 parts by mass or more, preferably 50 parts by mass or more, more preferably 100 parts by mass or more, and 300 parts by mass or less, preferably 200 parts by mass or less with respect to 100 parts by mass of the resin component.

Further, an average particle size of the aluminum hydroxide is, for example, 1 μm or more, and for example, 50 μm or less, preferably 25 μm or less.

The average particle size of the aluminum hydroxide can be determined by fabricating a particle size distribution curve with a laser diffraction-scattering particle size distribution measurement device, and by calculating the particle size corresponding to 50% by mass.

### <Expandable Graphite>

The expandable graphite is a graphite intercalation compound in which a sulfuric acid or the like is intercalated between layers of scaly natural graphite. The expandable graphite expands between layers at a temperature of about 150 to 300° C.

The average particle size of the expandable graphite is 150 μm or less, preferably, 100 μm or less, and for example, 10 μm or more, preferably 50 μm or more.

The expandable graphite is observed with an optical microscope, and as for any pieces of 50 expandable graphite, by measuring the maximum size (major axis) and the particle size in a direction perpendicular to the maximum size (minor axis), and by calculating the average value of the major axis and the minor axis, the average particle size of the expandable graphite can be determined.

As the expandable graphite, a commercially available product can be also used. More specifically, 9510045 manufactured by Ito Graphite Co., Ltd. is used.

The mixing ratio of the expandable graphite is described later.

### <Flame Retardant>

The flame retardant contains a phosphorus-containing flame retardant and a nitrogen-containing flame retardant.

Examples of the phosphorus-containing flame retardant include red phosphorus, phosphate esters, polyphosphates, and phosphinic acid metal salts.

Examples of the phosphate ester include trimethyl phosphate, triethyl phosphate, tributyl phosphate, and tricresyl phosphate.

Examples of the polyphosphate include ammonium polyphosphate and aluminum polyphosphate.

Examples of the phosphinic acid metal salt include aluminum trisdiethylphosphinate and aluminum trismethylphosphinate.

In addition, as the phosphorus-containing flame retardant, a commercially available product may be used. A specific example thereof includes the OP series (specifically, Exolit OP1230 (aluminum trisdiethylphosphinate), manufactured by Clariant AG).

As the phosphorus-containing flame retardant, preferably, a phosphinic acid metal salt is used, more preferably, an aluminum trisdiethylphosphinate is used.

These phosphorus-containing flame retardants may be used alone or in combination of two or more.

The mixing ratio of the phosphorus-containing flame retardant is, for example, 5 parts by mass or more, preferably 10 parts by mass or more, and for example, 25 parts by mass or less, preferably 20 parts by mass or less, more preferably 18 parts by mass or less with respect to 100 parts by mass of the resin component.

The phosphorus content of the phosphorus-containing flame retardant is described later.

The nitrogen-containing flame retardant is an auxiliary agent for suppressing thermal decomposition of the phosphorus-containing flame retardant. Specifically, the nitrogen-containing flame retardant generates a gas when thermally decomposed. The gas suppresses the thermal decomposition of the phosphorus-containing flame retardant. As a result, it is possible to improve heat insulation properties (discoloration after burning (described later)).

Examples of the nitrogen-containing flame retardant include triazine compounds.

The triazine compound is a compound having a triazine skeleton. Examples of the triazine compound include melamine, acetoguanamine, benzoguanamine, melon, melam, succinoguanamine, ethylene dimelamine, melamine polyphosphate, triguanamine, and melamine cyanurate.

Further, as the nitrogen-containing flame retardant, a commercially available product may be used. Specifically, MC-4000 (melamine cyanurate, manufactured by Nissan Chemical Corporation) is used.

As the nitrogen-containing flame retardant, preferably, a triazine compound is used. As the nitrogen-containing flame retardant, more preferably, a melamine cyanurate is used.

These nitrogen-containing flame retardants may be used alone or in combination of two or more.

The mixing ratio of the nitrogen-containing flame retardant is, for example, 1 part by mass or more, preferably 4 parts by mass or more, and for example, 25 parts by mass or less, preferably 20 parts by mass or less, more preferably 15 parts by mass or less, further more preferably 12 parts by mass or less with respect to 100 parts by mass of the resin component.

The nitrogen content of the nitrogen-containing flame retardant is described later.

Further, the flame retardant may also contain another flame retardant other than the phosphorus-containing flame retardant and the nitrogen-containing flame retardant.

Examples of the other flame retardant include halogenated flame retardants, diantimony trioxide, zinc stannate, and zinc borate.

These other flame retardants may be used alone or in combination of two or more.

The flame retardant preferably does not contain the other flame retardant, and consists of the phosphorus-containing flame retardant and the nitrogen-containing flame retardant.

Then, the resin composition is obtained by blending the resin component, the aluminum hydroxide, the expandable graphite, and the flame retardant.

Further, the additive may be also blended into the resin composition as needed as long as it does not inhibit the effect of the present invention.

Examples of the additive include polymerization inhibitors, curing agents, wetting dispersants, colorants, mold release agents, thickeners, pattern materials, antibacterial agents, hydrophilic agents, photocatalysts, ultraviolet absorbers, ultraviolet stabilizers, separation inhibitors, silane coupling agents, antistatic agents, thixo-imparting agent, thixo stabilizers, fillers (excluding the aluminum hydroxide), and polymerization accelerators. These additives may be used alone or in combination of two or more.

The polymerization inhibitor is blended so as to adjust pot life and a curing reaction.

Examples of the polymerization inhibitor include hydroquinone compounds, benzoquinone compounds, catechol compounds, phenol compounds, and N-oxyl compounds. As the polymerization inhibitor, preferably, a benzoquinone compound is used. Examples of the benzoquinone compound include p-benzoquinone and methyl-p-benzoquinone. As the benzoquinone compound, preferably, a p-benzoquinone is used.

The mixing ratio of the polymerization inhibitor is, for example, 0.001 parts by mass or more, preferably 0.1 parts by mass or more, and for example, 0.5 parts by mass or less with respect to 100 parts by mass of the resin component.

Examples of the curing agent include peroxides. Examples of the peroxide include benzoyl peroxide, t-butyl peroxyisopropyl carbonate, t-amyl peroxyisopropyl monocarbonate, t-hexyl peroxyisopropyl 1,1-bis(t-butyl peroxy)cyclohexane, t-butyl peroxy-2-ethylhexanoate, amyl peroxy-2-ethylhexanoate, 2-ethylhexyl peroxy-2-ethylhexanoate, t-butyl peroxybenzoate, t-hexyl peroxybenzoate, and t-hexyl peroxyacetate. As the curing agent, preferably, a t-butyl peroxyisopropyl carbonate is used.

These curing agents may be used alone or in combination of two or more.

The mixing ratio of the curing agent is, for example, 0.1 parts by mass or more, preferably 0.5 parts by mass or more, and for example, 5 parts by mass or less, preferably 2 parts by mass or less with respect to 100 parts by mass of the resin component.

The wetting dispersant is blended so as to optimize the viscosity of the resin composition.

Examples of the wetting dispersant include copolymers having an acid group, phosphoric acid polyesters, and alkylammonium salts.

Specifically, as the copolymer having an acid group, BYK-W995, BYK-W996, BYK-W9010 (hereinbefore, manufactured by BYK CHEMIE GmbH), or the like can be used.

Examples of the alkylammonium salt include alkylammonium salts of high molecular copolymers. Specifically, an example thereof includes BYK-9076 manufactured by BYK-CHEMIE GmbH having an amine value of 44 mg/KOH/g and the acid value of 38 mg/KOH/g.

These wetting dispersants may be used alone or in combination of two or more. As the wetting dispersant, preferably, a copolymer having an acid group and an alkylammonium salt are used in combination.

The mixing ratio of the wetting dispersant is, for example, 0.1 parts by mass or more, preferably 0.3 parts by mass or more, more preferably 1 part by mass or more, and for example, 5 parts by mass or less, preferably 2 parts by mass or less with respect to 100 parts by mass of the resin component.

The colorant is not particularly limited. Examples of the colorant include polyester toners obtained by mixing known pigments such as titanium oxide, carbon black, red oxide, and phthalocyanine blue thereto.

As the colorant, preferably, a polyester toner is used.

These colorants may be used alone or in combination of two or more.

The mixing ratio of the colorant is, for example, 1 part by mass or more, preferably 5 parts by mass or more, and for example, 20 parts by mass or less with respect to 100 parts by mass of the resin component.

Examples of the mold release agent include fatty acids, fatty acid metal salts, liquid wax, fluorine polymers, and silicon-based polymers. Examples of the fatty acid include stearic acid and lauric acid. Examples of the fatty acid metal salt include zinc stearate and calcium stearate.

As the mold release agent, preferably, a fatty acid metal salt is used, more preferably, a zinc stearate is used.

These mold release agents may be used alone or in combination of two or more.

The mixing ratio of the mold release agent is, for example, 1 part by mass or more, preferably 3 parts by mass or more, and for example, 10 parts by mass or less with respect to 100 parts by mass of the resin component.

The thickener is blended so as to thicken the viscosity of the resin composition suitable for heat compression molding. The thickener is preferably blended before (preferably, immediately before) the resin composition is impregnated into reinforcing fibers (described later).

Examples of the thickener include alkali earth metal oxides and alkali earth metal hydroxides. An example of the alkali earth metal oxide includes magnesium oxide. Examples of the alkali earth metal hydroxide include magnesium hydroxide and calcium hydroxide.

As the thickener, preferably, an alkali earth metal oxide is used. As the thickener, more preferably, a magnesium oxide is used.

These thickeners may be used alone or in combination of two or more.

The mixing ratio of the thickener is, for example, 0.5 parts by mass or more, and for example, 10 parts by mass or less, preferably 3 parts by mass or less with respect to 100 parts by mass of the resin component.

As described above, the resin composition is obtained.

Then, in the resin composition, the expandable graphite content, the phosphorus content of the phosphorus-containing flame retardant, the mass ratio of the nitrogen content of the nitrogen-containing flame retardant to the phosphorus content of the phosphorus-containing flame retardant (nitrogen content/phosphorus content), and the mass ratio of the expandable graphite content to the phosphorus content of the phosphorus-containing flame retardant (expandable graphite content/phosphorus content) are adjusted within a predetermined range.

Thus, it is possible to improve the heat insulation properties and moldability. The heat insulation properties can be estimated by the strength after burning measured by a burning test to be described later, and by the discoloration after burning measured by a flame resistance test to be described later.

The strength after burning shows the strength of the molded article obtained using the resin composition after heating under predetermined conditions. In the case of the excellent heat insulation properties, the strength is retained even after heating, and in the case of the low heat insulation properties, the strength may be lowered after heating, and the molded article may collapse.

Further, the discoloration after burning shows a presence or absence of the discoloration in a case where a flame is applied to the molded article obtained using the resin composition under the predetermined conditions. In the case of the excellent heat insulation properties, there is no discoloration, and in the case of the low heat insulation properties, there is discoloration.

More specifically, the mixing ratio of the expandable graphite is 1.0 part by mass or more, preferably 1.5 parts by mass or more, more preferably 2.0 parts by mass or more, further more preferably 2.5 parts by mass or more, particularly preferably 2.7 parts by mass or more, and below 5.0 parts by mass, preferably 4.8 parts by mass or less, more preferably 4.5 parts by mass or less, further more preferably 4.3 parts by mass or less with respect to 100 parts by mass of the resin component.

When the mixing ratio of the expandable graphite is the above-described lower limit or more, the heat insulation properties (discoloration after burning) are excellent.

On the other hand, when the mixing ratio of the expandable graphite is below the above-described lower limit, the heat insulation properties (discoloration after burning) are lowered.

Further, when the mixing ratio of the expandable graphite is below the above-described upper limit, the heat insulation properties (strength after burning) are excellent. On the other hand, when the mixing ratio of the expandable graphite is the above-described upper limit or more, the heat insulation properties (strength after burning) are lowered.

Further, when the mixing ratio of the expandable graphite is the above-described upper limit or less, the heat insulation properties (strength after burning) are excellent. On the other hand, when the mixing ratio of the expandable graphite is above the above-described upper limit, the heat insulation properties (strength after burning) are lowered.

Further, the phosphorus content of the phosphorus-containing flame retardant is 1.5 parts by mass or more, preferably 2.0 parts by mass or more, more preferably 2.5 parts by mass or more, further more preferably 3.0 parts by mass or more, particularly preferably 3.5 parts by mass or more, and 4.5 parts by mass or less, preferably 4.0 parts by mass or less with respect to 100 parts by mass of the resin component.

When the above-described phosphorus content is the above-described lower limit or more, the heat insulation properties (discoloration after burning and strength after burning) are excellent.

On the other hand, when the above-described phosphorus content is below the above-described lower limit, the heat insulation properties (discoloration after burning and strength after burning) are lowered.

Further, when the above-described phosphorus content is the above-described upper limit or less, the moldability is excellent.

On the other hand, when the above-described phosphorus content is above the above-described upper limit, the moldability is lowered.

The phosphorus content of the phosphorus-containing flame retardant is calculated by multiplying the phosphorus-containing flame retardant content by the content ratio of the phosphorus. The content ratio of the phosphorus can be calculated by dividing the amount obtained by multiplying the number of phosphorus contained in the molecular formula of the phosphorus-containing flame retardant by the atomic weight of the phosphorus by the molecular weight of the phosphorus-containing flame retardant.

In addition, the mass ratio of the nitrogen content of the nitrogen-containing flame retardant with respect to 100 parts by mass of the resin component to the phosphorus content of the phosphorus-containing flame retardant with respect to 100 parts by mass of the resin component (nitrogen content/phosphorus content) is 0.5 or more, preferably 0.6 or more, and 3.0 or less, preferably 2.5 or less, more preferably 2.0 or less, further more preferably 1.5 or less, particularly preferably 1.0 or less.

When the above-described mass ratio (nitrogen content/phosphorus content) is the above-described lower limit or more, the heat insulation properties (discoloration after burning) are excellent.

On the other hand, when the above-described mass ratio (nitrogen content/phosphorus content) is below the above-described lower limit, the heat insulation properties (discoloration after burning) are lowered.

Further, when the above-described mass ratio (nitrogen content/phosphorus content) is the above-described upper limit or less, the heat insulation properties (discoloration after burning) are excellent.

On the other hand, when the above-described mass ratio (nitrogen content/phosphorus content) is above the above-described upper limit, the heat insulation properties (discoloration after burning) are lowered.

The nitrogen content of the nitrogen-containing flame retardant is calculated by multiplying the nitrogen-containing flame retardant by the content ratio of the nitrogen. The content ratio of the nitrogen can be calculated by dividing the amount obtained by multiplying the number of nitrogen in the molecular formula of the nitrogen-containing flame retardant by the atomic weight of nitrogen by the molecular weight of the nitrogen-containing flame retardant.

In addition, the mass ratio of the expandable graphite content with respect to 100 parts by mass of the resin component to the phosphorus content of the phosphorus-containing flame retardant with respect to 100 parts by mass of the resin component (expandable graphite content/phosphorus content) is 0.5 or more, preferably 0.7 or more, and 2.0 or less, preferably 1.5 or less, more preferably 1.0 or less.

When the above-described mass ratio (expandable graphite content/phosphorus content) is the above-described lower limit or more, the heat insulation properties (discoloration after burning) are excellent.

On the other hand, when the above-described mass ratio (expandable graphite content/phosphorus content) is below the above-described lower limit, the heat insulation properties (discoloration after burning) are lowered.

Further, when the above-described mass ratio (expandable graphite content/phosphorus content) is the above-described upper limit or less, the heat insulation properties (strength after burning) are excellent.

On the other hand, when the above-described mass ratio (expandable graphite content/phosphorus content) is above the above-described upper limit, the heat insulation properties (strength after burning) are lowered.

The above-described mass ratio can be calculated by dividing the expandable graphite content (charged amount) by the above-described phosphorus content.

In addition, as the ratio other than the above-described ratio, the nitrogen content of the nitrogen-containing flame retardant is, for example, 1.0 part by mass or more, preferably 2.0 parts by mass or more, more preferably 2.3 parts by mass or more, and for example, 5.0 parts by mass or less, preferably 4.0 parts by mass or less, more preferably 3.0 parts by mass or less, further more preferably 2.8 parts by mass or less with respect to 100 parts by mass of the resin component.

When the above-described nitrogen content is the above-described lower limit or more, the heat insulation properties (discoloration after burning) are excellent.

Further, when the above-described nitrogen content is the above-described upper limit or less, the heat insulation properties (discoloration after burning) are excellent.

Then, the resin composition can produce the molded article having the excellent heat insulation properties and moldability.

In order to produce the molded article using such a resin composition, first, a molding material is prepared.

To prepare the molding material, the reinforcing fiber is blended into the resin composition.

Examples of the reinforcing fiber include inorganic fibers, organic fibers, and natural fibers. Examples of the inorganic fiber include glass fibers, carbon fibers, metal fibers, and ceramic fibers. Examples of the organic fiber include polyvinyl alcohol-based fibers, polyester-based fibers, polyamide-based fibers, fluororesin-based fibers, and phenol-based fibers. Examples of the natural fiber include hemp and kenaf.

As the reinforcing fiber, preferably, an inorganic fiber is used. As the reinforcing fiber, more preferably, a glass fiber is used.

Examples of a shape of the reinforcing fiber include cloth-shaped (for example, roving cloth), mat-shaped (for example, chopped strand mat, preformable mat, continuous strand mat, and surfacing mat), strand-shaped, roving-shaped, nonwoven fabric-shaped, and paper-shaped.

A length of the reinforcing fiber is not particularly limited, and is, for example, 1.5 mm or more, from the viewpoint of improving the strength, preferably 5 mm or more, more preferably 15 mm or more, and for example, 80 mm or less, preferably 40 mm or less.

Then, the molding material is, for example, obtained as a sheet-shaped molding material by impregnating the resin composition into the reinforcing fiber.

Examples of the method for preparing the molding material include known methods. Specifically, examples thereof include SMC (sheet molding compound), TMC (thick molding compound), and BMC (bulk molding compound). Preferably, SMC is used.

The content ratio of the reinforcing fiber is, for example, 15% by mass or more, and for example, 60% by mass or less with respect to the molding material.

Thus, the molding material containing the resin composition and the reinforcing fiber is obtained.

Next, such a molding material is aged for thickening the viscosity so as to enable the heat compression molding (described below).

In aging, an aging temperature is, for example, 20° C. or more, and for example, 50° C. or less. Further, aging time is, for example, 8 hours or more, and for example, 120 hours or less.

Thus, the molding material is, for example, retained in a sheet shape. That is, the molding material has a sheet shape.

Then, the molded article is obtained by subjecting the molding material to the heat compression molding by the known method.

The conditions of the heat compression molding are appropriately set in accordance with its purpose and applications. In the heat compression molding, a molding temperature is, for example, 100° C. or more, and for example, 200° C. or less. Also, molding pressure is, for example, 0.1 MPa or more, preferably 1 MPa or more, more preferably 5 MPa or more, and for example, 20 MPa or less, preferably 15 MPa or less.

Thus, the molded article is obtained by shaping and curing the molding material.

Since the molded article contains a cured product of the molding material described above, it has the excellent heat insulation properties.

The thickness of the molded article is, for example, 0.1 mm or more, preferably 1.0 mm or more, and for example, 10 mm or less, preferably 5 mm or less.

Then, such a molded article can be widely used in each member of, for example, building materials, housings, casting materials, mechanical parts (for example, battery cases of electrically powered vehicles), electronic and electrical components, vehicles, ships, and, aircrafts.

In the battery case of the electrically powered vehicle, in particular, the excellent heat insulation properties may be required due to delayed fire spread in the case of a vehicle fire.

On the other hand, the molded article can be preferably used for the battery case of the electrically powered vehicle due to its excellent heat insulation properties.

### <Function and Effect>

The resin composition contains the expandable graphite and the flame retardant, and as the flame retardant, contains the phosphorus-containing flame retardant and the nitrogen-containing flame retardant. Then, in the resin composition, the expandable graphite content, the phosphorus content of the phosphorus-containing flame retardant, the mass ratio of the nitrogen content of the nitrogen-containing flame retardant to the phosphorus content of the phosphorus-containing flame retardant (nitrogen content/phosphorus content), and the mass ratio of the expandable graphite content to the phosphorus content of the phosphorus-containing flame retardant (expandable graphite content/phosphorus content) are within the predetermined range. Therefore, it is possible to produce the molded article having the excellent heat insulation properties and moldability.

Specifically, as described above, the heat insulation properties can be estimated by the strength after burning and the discoloration after burning.

As described above, the expandable graphite expands between the layers at the temperature of about 150 to 300° C. When the expandable graphite is expanded, it becomes a heat insulating layer, so that the heat insulation properties are improved. Therefore, when the mixing ratio of the expandable graphite is low, there is a tendency to lower the discoloration after burning.

On the other hand, mechanical strength is lowered when the expandable graphite is expanded. Therefore, when the mixing ratio of the expandable graphite is large, there is a tendency to lower the strength after burning.

Therefore, in the resin composition, by setting the mixing ratio of the expandable graphite within the predetermined range, it is possible to achieve both the discoloration after burning and the strength after burning, and as a result, to improve the heat insulation properties.

Further, the phosphorus-containing flame retardant imparts the flame retardancy. Therefore, when the phosphorus content of the phosphorus-containing flame retardant is small, there is a tendency to lower the heat insulation properties (discoloration after burning and strength after burning).

On the other hand, when the phosphorus content of the phosphorus-containing flame retardant is large, there is a tendency to lower the moldability.

Therefore, in the resin composition, by setting the phosphorus content of the phosphorus-containing flame retardant within the predetermined range, it is possible to achieve both the heat insulation properties and the moldability.

Further, as described above, the gas which is generated by the thermal decomposition of the nitrogen-containing flame retardant suppresses the thermal decomposition of the phosphorus-containing flame retardant.

Therefore, when the nitrogen-containing flame retardant is sufficient with respect to the phosphorus-containing flame retardant, it is possible to suppress the thermal decomposition of the phosphorus-containing flame retardant, and as a result, to improve the discoloration after burning.

In other words, when the mass ratio of the nitrogen content of the nitrogen-containing flame retardant to the phosphorus content of the phosphorus-containing flame retardant (nitrogen content/phosphorus content) is small (when the nitrogen-containing flame retardant is small with respect to the phosphorus-containing flame retardant), the discoloration after burning is lowered.

On the other hand, when the mass ratio of the nitrogen content of the nitrogen-containing flame retardant to the phosphorus content of the phosphorus-containing flame retardant (nitrogen content/phosphorus content) is large (when the nitrogen-containing flame retardant is large with respect to the phosphorus-containing flame retardant), the discoloration after burning is lowered.

In the resin composition, since the mass ratio of the nitrogen content of the nitrogen-containing flame retardant to the phosphorus content of the phosphorus-containing flame retardant (nitrogen content/phosphorus content) is within the predetermined range, it is possible to improve the discoloration after burning.

In addition, when the mass ratio of the expandable graphite content to the phosphorus content of the phosphorus-containing flame retardant (expandable graphite content/phosphorus content) is small (when the phosphorus content of the phosphorus-containing flame retardant is large with respect to the expandable graphite), the phosphorus inhibits the expansion of the expandable graphite, so that the heat insulation properties are lowered, and the discoloration after burning.is lowered.

On the other hand, when the mass ratio of the expandable graphite content to the phosphorus content of the phosphorus-containing flame retardant (expandable graphite content/phosphorus content) is large (when the phosphorus content of the phosphorus-containing flame retardant is small with respect to the expandable graphite), the layer formed by the expansion of the expandable graphite easily collapses at the time of burning, so that the heat insulation properties are lowered, and the strength after burning is lowered.

In the resin composition, since the mass ratio of the expandable graphite content to the phosphorus content of the phosphorus-containing flame retardant (expandable graphite content/phosphorus content) is within the predetermined range, it is possible to improve the heat insulation properties (discoloration after burning/strength after burning).

As described above, in the resin composition, by setting the expandable graphite content, the phosphorus content of the phosphorus-containing flame retardant, the mass ratio of the nitrogen content of the nitrogen-containing flame retardant to the phosphorus content of the phosphorus-containing flame retardant (nitrogen content/phosphorus content), and the mass ratio of the expandable graphite content to the phosphorus content of the phosphorus-containing flame retardant (expandable graphite content/phosphorus content) within the predetermined range, it is possible to achieve both the heat insulation properties and the moldability.

The molding material contains the above-described resin composition. Therefore, it is possible to produce the molded article having the excellent heat insulation properties and moldability.

The molded article contains the cured product of the above-described molding material. Therefore, it has the excellent heat insulation properties and moldability.

### Examples

The specific numerical values in mixing ratio (content ratio), property value, and parameter used in the following description can be replaced with upper limit values (numerical values defined as “or less” or “below”) or lower limit values (numerical values defined as “or more” or “above”) of corresponding numerical values in mixing ratio (content ratio), property value, and parameter described in the above-described “DESCRIPTION OF EMBODIMENTS”. All designations of “part” or “parts” and “%” mean part or parts by mass and % by mass, respectively, unless otherwise particularly specified.

### <Details of Component>

The details of components used in the following Examples and Comparative Examples are shown below.
Unsaturated polyester resin 1: unsaturated polyester resin of Synthesis Example 1, styrene content of 40% by mass
Unsaturated polyester resin 2: unsaturated polyester resin of Synthesis Example 2, styrene content of 40% by mass
Vinyl ester resin: vinyl ester resin of Synthesis Example 3, styrene content of 40% by mass
Saturated polyester resin: low shrinkage agent, saturated polyester resin of Synthesis Example 4, styrene content of 40% by mass
Styrene-based thermoplastic elastomer solution: low shrinkage agent, G1701, manufactured by KRATON CORPORATION
Polyvinyl acetate solution: low shrinkage agent, styrene content of 65% by mass of polyvinyl acetate (number average molecular weight of 30000)
Polystyrene solution: low shrinkage agent, styrene content of 65% by mass of polystyrene (number average molecular weight of about 110000)
Polyethylene powder: low shrinkage agent
Copolymer having acid group: BYK-W9010, manufactured by BYK-CHEMIE GmbH
Alkylammonium salt of high molecular copolymer: BYK-9076, manufactured by BYK-CHEMIE GmbH
9510045: expandable graphite, average particle size of 70 μm, manufactured by Ito Graphite Co., Ltd.
OP1230: phosphorus-containing flame retardant, aluminum trisdiethylphosphinate, content ratio of phosphorus of 24% by mass, trade name: “Exolit OP1230”, manufactured by Clariant AG
MC-4000: nitrogen-containing flame retardant, melamine cyanurate, content ratio of nitrogen of 49% by mass, trade name: “MC-4000”, manufactured by Nissan Chemical Corporation
Aluminum hydroxide: average particle size of 8 μm

### Preparation of Unsaturated Polyester Resin

### Synthesis Example 1

A flask equipped with a thermometer, a nitrogen gas introduction pipe, a reflux condenser, and a stirrer was charged with 10.0 mol of the maleic anhydride, 6.5 mol of the propylene glycol, and 4.0 mol of the neopentyl glycol. Thereafter, a polycondensation reaction was carried out at 200° C. to 210° C. by stirring under a nitrogen gas atmosphere. Thus, the unsaturated polyester having the acid value of 26.5 mgKOH/g was obtained. A method for measuring the acid value was in conformity with JIS K6901 (2008). Next, 0.02 parts by mass of the hydroquinone as the polymerization inhibitor and 66.7 parts by mass of the styrene were added to 100 parts by mass of the unsaturated polyester, and these were uniformly mixed. Thus, the unsaturated polyester resin (styrene content of 40% by mass) was obtained.

### Synthesis Example 2

The flask equipped with the thermometer, the nitrogen gas introduction pipe, the reflux condenser, and the stirrer was charged with 3.3 mol of the isophthalic acid and 10.5 mol of the propylene glycol. Thereafter, the polycondensation reaction was carried out at 200° C. to 210° C. by stirring under the nitrogen gas atmosphere. Thereafter, when the acid value of the reaction product became 20 mgKOH/g, the obtained product was cooled to 150° C. Next, 6.7 mol of the maleic anhydride was charged and reacted again at 210° C. to 220° C. Then, the unsaturated polyester having the acid value of 27.5 mgKOH/g was obtained. As the polymerization inhibitor, 0.01 parts by mass of the hydroquinone and 66.7 parts by mass of the styrene were added with respect to 100 parts by mass of the unsaturated polyester, and these were uniformly mixed. Thus, the unsaturated polyester resin (styrene content of 40% by mass) was obtained.

### Preparation of Vinyl Ester Resin

### Synthesis Example 3

The flask equipped with the stirrer, the reflux condenser, and the gas introduction pipe was charged with 1850 parts by mass (10.0 equivalents) of the bisphenol A-type epoxy compound (epoxy equivalent of 185 g/eq), 317 parts by mass (2.78 equivalents) of the bisphenol A, and 1.0 part by mass of the triethylbenzylammonium chloride as the catalyst. Next, the obtained product was reacted at 170° C. for 5 hours by blowing nitrogen thereto. Thus, the epoxy resin (bisphenol-type epoxy resin) having the epoxy equivalent of 298 g/eq was obtained. Thereafter, the mixture was cooled to 120° C., and 1.0 part by mass of the hydroquinone (polymerization inhibitor), 5.0 parts by mass of the triethylbenzyl ammonium chloride (catalyst), and 636 parts by mass (7.40 equivalents) of the methacrylic acid were added. Next, the resulting mixture was reacted at 110° C. for 8 hours by blowing the air thereto. Thus, the vinyl ester having the acid value of 8.0 mgKOH/g was obtained. Next, 1869 parts by mass of the styrene was added to the vinyl ester (66.7 parts by mass with respect to 100 parts by mass of the vinyl ester). Thus, the vinyl ester resin (content ratio of the styrene of 40% by mass) was obtained.

### Preparation of Saturated Polyester Resin

### Synthesis Example 4

The flask equipped with the thermometer, the nitrogen gas introduction pipe, the reflux condenser, and the stirrer was charged with 4.0 mol of the isophthalic acid and 10.5 mol of the neopentyl glycol. Thereafter, the polycondensation reaction was carried out at 200° C. to 210° C. by stirring under the nitrogen gas atmosphere. Thereafter, when the acid value of the reaction product became 10 mgKOH/g, the obtained product was cooled to 150° C. Next, 6.0 mol of the adipic acid was charged and reacted again at 210° C. to 220° C. Thus, the saturated polyester having the acid value of 9.5 mgKOH/g was obtained. As the polymerization inhibitor, 0.015 parts by mass of the hydroquinone and 66.7 parts by mass of the styrene were added with respect to 100 parts by mass of the saturated polyester, and these were uniformly mixed. Thus, the saturated polyester resin (content ratio of the styrene of 40% by mass) was obtained.

### Production of Resin Composition, Molding Material, and Molded Article

### Examples 1 to 12 and Comparative Examples 1 to 13

### [Production of Resin Composition]

Each component was blended based on the descriptions of Tables 1 to 4, thereby preparing the resin composition. The thickener was blended immediately before the resin composition was impregnated into the reinforcing fiber.

### [Production of Molding Material]

By using a known sheet molding compound (SMC) impregnating machine, a glass roving was continuously cut into 25 mm on the resin composition coated onto a carrier film using a doctor blade and added so as to have the content ratio of the glass fiber of 35% by mass (25.5% by volume), and an impregnation step was carried out, thereby obtaining the molding material (sheet molding compound (SMC)). Next, the molding material was aged at 40° C. for 48 hours, and the viscosity thereof was thickened until the molding material was in a heat compression moldable state.

### [Production of Molded Article]

The molding material was subjected to the heat compression molding using a flat metal plate of 300 mm×300 mm, thereby producing the flat plate-shaped molded articles each having a thickness of 2.5 mm and 2.3 mm.

The molding was carried out under the conditions of a mold temperature of both the product surface and the rear surface of 140° C., the molding pressure of 10 MPa, and retaining time in a mold of 300 seconds. Thereafter, the molded article was demolded from the mold, and cooled immediately by being sandwiched between iron plates. Thus, the flat plate-shaped molded article was produced.

### Evaluation

### Heat Insulation Properties

### (Burning Test)

A test piece (85 mm×25 mm) was cut-processed from each of the molded articles (thickness of 2.5 mm) of Examples and Comparative Examples. Next, the test piece was placed in a melting pot, and subjected to treatment at a set temperature of 600° C. for 1 hour using an electric oven. Thereafter, the temperature thereof was cooled to room temperature, and the test piece was taken out from the electric oven to confirm its state. The strength after burning was evaluated based on the following criteria. The results are shown in Tables 1 to 4.

### (Criteria):

◯: the test piece could be held with a finger.
X: when the test piece was tried to be held with a finger, it collapsed.

### (Flame Resistance Test)

A test piece (150 mm×150 mm) was cut-processed from each of the molded articles (thickness of 2.3 mm) of Examples and Comparative Examples. Next, by using a commercially available cooking burner (cassette gas cooking burner CJ2, manufactured by Iwatani Corporation), an inner flame length of the burner was adjusted to about 40 mm, and an inner flame front end temperature was adjusted to about 1000° C. In addition, the central portion of the test piece was fixed to be in a vertical position 40 mm from the front end of the burner. The burner was fired and stopped in five minutes, and the state of the molding plate was visually observed. The above-described test was carried out five times. The strength after burning was evaluated based on the following criteria. The results are shown in Tables 1 to 4.

### (Criteria):

◯: the number of times the rear surface of the test piece was discolored by scorching was 0 to 1.
Δ: the number of times the rear surface of the test piece was discolored by scorching was 2.
X: the number of times the rear surface of the test piece was discolored by scorching was 3 to 5.

### (Moldability)

Each of the molding materials of Examples and Comparative Examples was cut out into 15 cm×15 cm to be stacked in four layers. This was disposed in the central portion of the flat metal plate having 300 mm×300 mm, and heated under the conditions of the mold temperature of both the product surface and the rear surface of 140° C., the molding pressure of 10 MPa, and the retaining time in the mold of 300 seconds. Thus, the molded article was produced. Thereafter, the molded article was demolded from the mold, and cooled immediately by being sandwiched between the iron plates. The moldability was evaluated based on the following criteria. The results are shown in Tables 1 to 4.

### (Criteria):

◯: the resin composition was filled up to the end portion of the molded article.
◯: the resin composition was not filled up to the end portion of the molded article.

### (Bending Strength)

The bending strength at 23° C. of each of the molded articles (thickness of 2.3 mm) of Examples and Comparative Examples was measured in conformity with JIS K7017 (1999). The results are shown in Tables 1 to 4.

TABLE 1

| Ex. No. | | | | | Ex. 1 | Ex. 2 | Ex. 3 | Ex. 4 | Ex. 5 | Ex. 6 | Ex. 7 |
|---|---|---|---|---|---|---|---|---|---|---|---|
| Molding | Resin | Resin | Radically | Unsaturated Polyester | 50 | — | 50 | 50 | 50 | 50 | 50 |
| Material | Composition | Component | Polymerizable | Resin 1 | | | | | | | |
| | (parts by | | Resin | Unsaturated Polyester | — | 60 | — | — | — | — | — |
| | mass) | | | Resin 2 | | | | | | | |
| | | | | Vinyl Ester Resin of | 10 | 10 | — | 10 | 10 | 10 | 10 |
| | | | | Synthesis Rx. 3 | | | | | | | |
| | | | Polymerizable Monomer | | 5 | 10 | 5 | 5 | 5 | 5 | 5 |
| | | | Low Shrinkage | Saturated Polyester | 20 | — | — | 20 | 20 | 20 | 20 |
| | | | Agent | Resin | | | | | | | |
| | | | | of Synthesis Ex. 4 | | | | | | | |
| | | | | Styrene-Based | — | — | 30 | — | — | — | — |
| | | | | Thermoplastic | | | | | | | |
| | | | | Elastomer Solution | | | | | | | |
| | | | | Polyvinyl Acetate | 15 | — | — | 15 | 15 | 15 | 15 |
| | | | | Solution | | | | | | | |
| | | | | Polystyrene Solution | — | 15 | 15 | — | — | — | — |
| | | | | Polyethylene Powder | — | 5 | — | — | — | — | — |
| | | Polymerization | p-benzoquinone | | 0.05 | 0.05 | 0.05 | 0.05 | 0.05 | 0.05 | 0.05 |
| | | Inhibitor | | | | | | | | | |
| | | Curing Agent | t-butylperoxy Isopropyl Carbonate | | 1.0 | 1.0 | 1.0 | 1.0 | 1.0 | 1.0 | 1.0 |
| | | Wetting | Copolymer Having Acid Group | | 1.0 | 1.0 | 1.0 | 1.0 | 1.0 | 1.0 | 1.0 |
| | | Dispersant | Alkylammonium Salt of High | | 0.5 | 0.5 | 0.5 | 0.5 | 0.5 | 0.5 | 0.5 |
| | | | Molecular Polymer | | | | | | | | |
| | | Expandable | 9510045 | | 3.0 | 3.0 | 3.0 | 2.5 | 2.5 | 2.5 | 2.5 |
| | | Graphite | | | | | | | | | |
| | | Flame | Phosphorus- | Aluminum | 15 | 15 | 15 | 10 | 15 | 10 | 7.5 |
| | | Retardant | Containing Flame | Trisdiethylphosphinate | | | | | | | |
| | | | Retardant | | | | | | | | |
| | | | Nitrogen- | Melamine Cyanurate | 5 | 5 | 5 | 5 | 5 | 10 | 7.5 |
| | | | Containing Flame | | | | | | | | |
| | | | Retardant | | | | | | | | |

| | | | | | | | | |
|---|---|---|---|---|---|---|---|---|
| Colorant | Black Polyester Toner | 10 | 10 | 10 | 10 | 10 | 10 | 10 |
| Mold Release | Zinc Stearate | 5 | 5 | 5 | 5 | 5 | 5 | 5 |
| Agent | | | | | | | | |
| Filler | Aluminum Hydroxide | 120 | 120 | 120 | 120 | 120 | 120 | 120 |
| Thickener | Magnesium Oxide | 0.8 | 0.8 | 0.8 | 0.8 | 0.8 | 0.8 | 0.8 |

| | Reinforcing Fiber | 1-inch Glass Fiber | 35 | 35 | 35 | 35 | 35 | 35 | 35 |
|---|---|---|---|---|---|---|---|---|---|
| | (% by mass) | | | | | | | | |
| Expandable Graphite Content to 100 parts by mass of | | | 3.00 | 3.00 | 3.00 | 2.50 | 2.50 | 2.50 | 2.50 |
| Resin Component (parts by mass) | | | | | | | | | |
| Phosphorous Content of Phosphorous-Containing Flame Retardant to | | | 3.60 | 3.60 | 3.60 | 2.40 | 3.60 | 2.40 | 1.80 |
| 100 parts by mass of Resin Component (parts by mass) | | | | | | | | | |
| Mass Ratio of Nitrogen Content of Nitrogen-Containing Flame | | | 0.68 | 0.68 | 0.68 | 1.02 | 0.68 | 2.04 | 2.04 |
| Retardant to 100 parts by mass of Resin Component to | | | | | | | | | |
| Phosphorus Content of Phosphorus-Containing Flame Retardant to 100 parts | | | | | | | | | |
| by mass of Resin Component (Nitrogen Content/Phosphorus Content) | | | | | | | | | |
| Mass Ratio of Expandable Graphite Content to 100 parts by mass of | | | 0.83 | 0.83 | 0.83 | 1.04 | 0.69 | 1.04 | 1.39 |
| Resin Component to Phosphorus Content of Phosphorus-Containing | | | | | | | | | |
| Flame Retardant to 100 parts by mass of Resin Component | | | | | | | | | |
| (Expandable Graphite Content/Phosphorus Content) | | | | | | | | | |
| Nitrogen Content of Nitrogen-Containing Flame Retardant to 100 parts | | | 2.45 | 2.45 | 2.45 | 2.45 | 2.45 | 4.90 | 3.68 |
| by mass of Resin Component (parts by mass) | | | | | | | | | |
| Eval- | Heat Insulation Properties | Strength after Burning | ◯ | ◯ | ◯ | ◯ | ◯ | ◯ | ◯ |
| uation | | Discoloration after Burning | ◯ | ◯ | ◯ | ◯ | ◯ | Λ | Λ |

| | | | | | | | |
|---|---|---|---|---|---|---|---|
| Moldability | ◯ | ◯ | ◯ | ◯ | ◯ | ◯ | ◯ |
| Bending Strength (Mpa) | 278 | 275 | 277 | 280 | 278 | 278 | 281 |

TABLE 2

| Ex. No. | | | | | Ex. 8 | Ex. 9 | Ex. 10 | Ex. 11 | Ex. 12 |
|---|---|---|---|---|---|---|---|---|---|
| Molding | Resin | Resin | Radically | Unsaturated Polyester | 50 | 50 | 50 | 50 | 50 |
| Material | Composition | Component | Polymerizable | Resin 1 | | | | | |
| | (parts by | | Resin | Unsaturated Polyester | — | — | — | — | — |
| | mass) | | | Resin 2 | | | | | |
| | | | | Vinyl Ester Resin of | 10 | 10 | 10 | 10 | 10 |
| | | | | Synthesis Ex. 3 | | | | | |
| | | | Polymerizable Monomer | | 5 | 5 | 5 | 5 | 5 |
| | | | Low | Saturated Polyester | 20 | 20 | 20 | 20 | 20 |
| | | | Shrinkage | Resin | | | | | |
| | | | Agent | of Synthesis Ex. 4 | | | | | |
| | | | | Styrene-Based | — | — | — | — | — |
| | | | | Thermoplastic | | | | | |
| | | | | Elastomer | | | | | |
| | | | | Solution | | | | | |
| | | | | Polyvinyl Acctate | 15 | 15 | 15 | 15 | 15 |
| | | | | Solution | | | | | |
| | | | | Polystyrene Solution | — | — | — | — | — |
| | | | | Polyethylene Powder | — | — | — | — | — |
| | | Polymerization | p-benzoquinone | | 0.05 | 0.05 | 0.05 | 0.05 | 0.05 |
| | | Inhibitor | | | | | | | |
| | | Curing Agent | t-butylperoxy Isopropyl Carbonate | | 1.0 | 1.0 | 1.0 | 1.0 | 1.0 |
| | | Wetting | Copolymer Having Acid Group | | 1.0 | 1.0 | 1.0 | 1.0 | 1.0 |
| | | Dispersant | Alkylammonium Salt of | | 0.5 | 0.5 | 0.5 | 0.5 | 0.5 |
| | | | High Molecular Polymer | | | | | | |
| | | Expandable | 9510045 | | 1.2 | 4.5 | 3.0 | 3.0 | 4.8 |
| | | Graphite | | | | | | | |
| | | | Phosphorus- | Aluminum | 9 | 15 | 9 | 7.5 | 11 |
| | | Flame | Containing Flame | Trisdiethylphosphinate | | | | | |
| | | Retardant | Retardant | | | | | | |
| | | | Nitrogen- | Melaminc Cyanurate | 3 | 5 | 3 | 10 | 5 |
| | | | Containing Flame | | | | | | |
| | | | Retardant | | | | | | |

| | | Colorant | Black Polyester Toner | 10 | 10 | 10 | 10 | 10 |
|---|---|---|---|---|---|---|---|---|
| | | Mold Release | Zinc Stearate | 5 | 5 | 5 | 5 | 5 |
| | | Agent | | | | | | |
| | | Filler | Aluminum Hydroxide | 120 | 120 | 120 | 120 | 120 |
| | | Thickener | Magnesium Oxide | 0.8 | 0.8 | 0.8 | 0.8 | 0.8 |
| | Reinforcing Fiber (% by mass) | | 1-inch Glass Fiber | 35 | 35 | 35 | 35 | 35 |
| Expandable Graphite Content to 100 parts by mass of Resin Component (parts by mass) | | | | 1.20 | 4.50 | 3.00 | 3.00 | 4.80 |
| Phosphorous Content of Phosphorous-Containing Flame Retardant to 100 parts | | | | 2.16 | 3.60 | 2.16 | 1.80 | 2.64 |
| by mass of Resin Component (parts by mass) | | | | | | | | |
| Mass Ratio of Nitrogen Content of Nitrogen-Containing Flame | | | | 0.68 | 0.68 | 0.68 | 2.72 | 0.93 |
| Retardant to 100 parts by mass of Resin Component to | | | | | | | | |
| Phosphorus Content of Phosphorus-Containing Flame | | | | | | | | |
| Retardant to 100 parts by mass of Resin Component | | | | | | | | |
| (Nitrogen Content/Phosphorus Content) | | | | | | | | |
| Mass Ratio of Expandable Graphite Content to 100 parts by mass of | | | | 0.56 | 1.25 | 1.39 | 1.67 | 1.82 |
| Resin Component to Phosphorus Content of Phosphorus- | | | | | | | | |
| Containing Flame Retardant to 100 parts by mass of Resin Component | | | | | | | | |
| (Expandable Graphite Content/Phosphorus Content) | | | | | | | | |
| Nitrogen Content of Nitrogen-Containing Flame Retardant to 100 parts | | | | 1.47 | 2.45 | 1.47 | 4.90 | 2.45 |
| by mass of Resin Component (parts by mass) | | | | | | | | |
| Eval- | Heat Insulation Properties | | Strength after Burning | ◯ | ◯ | ◯ | ◯ | ◯ |
| uation | | | Discoloration after Burning | Δ | ◯ | Δ | Δ | ◯ |

| | | | | | |
|---|---|---|---|---|---|
| Moldability | ◯ | ◯ | ◯ | ◯ | ◯ |
| Bending Strength (Mpa) | 280 | 278 | 282 | 277 | 278 |

TABLE 3

| | | | | | Com- | Com- | Com- | Com- | Com- | Com- | Com- |
|---|---|---|---|---|---|---|---|---|---|---|---|
| | | | | | parative | parative | parative | parative | parative | parative | parative |
| Comparative Ex. No. | | | | | Ex. 1 | Ex. 2 | Ex. 3 | Ex. 4 | Ex. 5 | Ex. 6 | Ex. 7 |
| Molding | Resin | Resin | Radically | Unsaturated | 50 | 50 | 50 | 50 | 50 | 50 | 50 |
| Material | Composition | Component | Polymerizable | Polyester Resin 1 | | | | | | | |
| | (parts by | | Resin | Unsaturated | — | — | — | — | — | — | — |
| | mass) | | | Polyester Resin 2 | | | | | | | |
| | | | | Vinyl Ester Resin | 10 | 10 | 10 | 10 | 10 | 10 | 10 |
| | | | | of Synthesis Ex. 3 | | | | | | | |
| | | | Polymerizable Monomer | | 5 | 5 | 5 | 5 | 5 | 5 | 5 |
| | | | Low | Saturated | 20 | 20 | 20 | 20 | 20 | 20 | 20 |
| | | | Shrinkage | Polyester Resin | | | | | | | |
| | | | Agent | of Synthesis Ex. 4 | | | | | | | |
| | | | | Styrene-Based | — | — | — | — | — | — | — |
| | | | | Thermoplastic | | | | | | | |
| | | | | Elastomer Solution | | | | | | | |
| | | | | Polyvinyl Acetate | 15 | 15 | 15 | 15 | 15 | 15 | 15 |
| | | | | Solution | | | | | | | |
| | | | | Polystyrene | — | — | — | — | — | — | — |
| | | | | Solution | | | | | | | |
| | | | | Polyethylene | — | — | — | — | — | — | — |
| | | | | Powder | | | | | | | |
| | | Polymerization | p-benzoquinone | | 0.05 | 0.05 | 0.05 | 0.05 | 0.05 | 0.05 | 0.05 |
| | | Inhibitor | | | | | | | | | |
| | | Curing Agent | t-butylperoxy Isopropyl Carbonate | | 1.0 | 1.0 | 1.0 | 1.0 | 1.0 | 1.0 | 1.0 |
| | | Wetting | Copolymer Having Acid Group | | 1.0 | 1.0 | 1.0 | 1.0 | 1.0 | 1.0 | 1.0 |
| | | Dispersant | Alkylammonium Salt of High | | 0.5 | 0.5 | 0.5 | 0.5 | 0.5 | 0.5 | 0.5 |
| | | | Molecular Polymer | | | | | | | | |
| | | Expandable | 9510045 | | 2.5 | 0.9 | 0.9 | 5.0 | 1.6 | 4.0 | 3.0 |
| | | Graphite | | | | | | | | | |
| | | Flame | Phosphorus- | Aluminum | 7.5 | 15 | 15 | 15 | 5 | 20 | 15 |
| | | Retardant | Containing Flame | Trisdiethyl- | | | | | | | |
| | | | Retardant | phosphinate | | | | | | | |
| | | | Nitrogen- | Melamine | 12.5 | 3.5 | 5 | 5 | 2.6 | 7 | 3 |
| | | | Containing Flame | Cyanurate | | | | | | | |
| | | | Retardant | | | | | | | | |

| | | | | | | | | |
|---|---|---|---|---|---|---|---|---|
| Colorant | Black Polyester Toner | 10 | 10 | 10 | 10 | 10 | 10 | 10 |
| Mold Release | Zinc Stearate | 5 | 5 | 5 | 5 | 5 | 5 | 5 |
| Agent | | | | | | | | |
| Filler | Aluminum Hydroxide | 120 | 120 | 120 | 120 | 120 | 120 | 120 |
| Thickener | Magnesium Oxide | 0.8 | 0.8 | 0.8 | 0.8 | 0.8 | 0.8 | 0.8 |

| | Reinforcing Fiber (% by mass) | 1-inch Glass Fiber | 35 | 35 | 35 | 35 | 35 | 35 | 35 |
|---|---|---|---|---|---|---|---|---|---|
| Expandable Graphite Content to 100 parts by mass of Resin | | | 2.50 | 0.90 | 0.90 | 5.00 | 1.60 | 4.00 | 3.00 |
| Component (parts by mass) | | | | | | | | | |
| Phosphorous Content of Phosphorous-Containing Flame Retardant to 100 parts | | | 1.80 | 3.60 | 3.60 | 3.60 | 1.20 | 4.80 | 3.60 |
| by mass of Resin Component (parts by mass) | | | | | | | | | |
| Mass Ratio of Nitrogen Content of Nitrogen-Containing Flame | | | 3.40 | 0.48 | 0.68 | 0.68 | 1.06 | 0.71 | 0.41 |
| Retardant to 100 parts by mass of Resin Component to | | | | | | | | | |
| Phosphorus Content of Phosphorus-Containing Flame Retardant to 100 parts | | | | | | | | | |
| by mass of Resin Component (Nitrogen Content/Phosphorus Content) | | | | | | | | | |
| Mass Ratio of Expandable Graphite Content to 100 parts by mass of | | | 1.39 | 0.25 | 0.25 | 1.39 | 1.33 | 0.83 | 0.83 |
| Resin Component to Phosphorus Content of Phosphorus- | | | | | | | | | |
| Containing Flame Retardant to 100 parts by mass of Resin Component | | | | | | | | | |
| (Expandable Graphite Content/Phosphorus Content) | | | | | | | | | |
| Nitrogen Content of Nitrogen-Containing Flame Retardant to 100 parts by | | | 6.13 | 1.72 | 2.45 | 2.45 | 1.27 | 3.43 | 1.47 |
| mass of Resin Component (parts by mass) | | | | | | | | | |
| Eval- | Heat Insulation Properties | Strength after Burning | ◯ | ◯ | ◯ | X | X | ◯ | ◯ |
| uation | | Discoloration after Burning | X | X | X | ◯ | X | ◯ | X |

| | | | | | | | |
|---|---|---|---|---|---|---|---|
| Moldability | ◯ | ◯ | ◯ | ◯ | ◯ | X | ◯ |
| Bending Strength (Mpa) | 278 | 280 | 278 | 282 | 279 | 262 | 278 |

TABLE 4

| | | | | | Com- | Com- | Com- | Com- | Com- | Com- |
|---|---|---|---|---|---|---|---|---|---|---|
| | | | | | parative | parative | parative | parative | parative | parative |
| Comparative Ex. No. | | | | | F.x. 8 | Fx. 9 | Rx. 10 | Ex. 11 | Fx. 12 | Fx. 13 |
| Molding | Resin | Resin | Radically | Unsaturated | 50 | 50 | 50 | 50 | 50 | 50 |
| Material | Composition | Component | Polymerizable | Polyester Resin 1 | | | | | | |
| | (parts by | | Resin | Unsaturated | — | — | — | — | — | — |
| | mass) | | | Polyester Resin 2 | | | | | | |
| | | | | Vinyl Ester Resin | 10 | 10 | 10 | 10 | 10 | 10 |
| | | | | of Synthesis Ex. 3 | | | | | | |
| | | | Polymerizable Monomer | | 5 | 5 | 5 | 5 | 5 | 5 |
| | | | Low | Saturated Polyester | 20 | 20 | 20 | 20 | 20 | 20 |
| | | | Shrinkage | Resin of Synthesis | | | | | | |
| | | | Agent | Ex. 4 | | | | | | |
| | | | | Styrene-Based | — | — | — | — | — | — |
| | | | | Thermoplastic | | | | | | |
| | | | | Elastomer Solution | | | | | | |
| | | | | Polyvinyl Acetate | 15 | 15 | 15 | 15 | 15 | 15 |
| | | | | Solution | | | | | | |
| | | | | Polystyrene Solution | — | — | — | — | — | — |
| | | | | Polyethylene Powder | — | — | — | — | — | — |
| | | Polymerization | p-benzoquinone | | 0.05 | 0.05 | 0.05 | 0.05 | 0.05 | 0.05 |
| | | Inhibitor | | | | | | | | |
| | | Curing Agent | t-butylperoxy Isopropyl Carbonate | | 1.0 | 1.0 | 1.0 | 1.0 | 1.0 | 1.0 |
| | | Wetting | Copolymer Having Acid Group | | 1.0 | 1.0 | 1.0 | 1.0 | 1.0 | 1.0 |
| | | Dispersant | Alkylammonium Salt of High | | 0.5 | 0.5 | 0.5 | 0.5 | 0.5 | 0.5 |
| | | | Molecular Polymer | | | | | | | |
| | | Expandable | 9510045 | | 1.5 | 4.9 | — | 2.5 | 2.5 | — |
| | | Graphite | | | | | | | | |
| | | Flame | Phosphorus- | Aluminum | 15 | 9 | 15 | — | 15 | 22 |
| | | Retardant | Containing Flame | Trisdiethylphosphinate | | | | | | |
| | | | Retardant | | | | | | | |
| | | | Nitrogen- | Melamine Cyanurate | 5 | 3 | 5 | 10 | — | 20 |
| | | | Containing Flame | | | | | | | |
| | | | Retardant | | | | | | | |

| | | | | | | | |
|---|---|---|---|---|---|---|---|
| Colorant | Black Polyester Toner | 10 | 10 | 10 | 10 | 10 | 10 |
| Mold Release | Zinc Stearate | 5 | 5 | 5 | 5 | 5 | 5 |
| Agent | | | | | | | |
| Filler | Aluminum Hydroxide | 120 | 120 | 120 | 120 | 120 | 120 |
| Thickener | Magnesium Oxide | 0.8 | 0.8 | 0.8 | 0.8 | 0.8 | 0.8 |

| | Reinforcing Fiber (% by mass) | 1-inch Glass Fiber | 35 | 35 | 35 | 35 | 35 | 35 |
|---|---|---|---|---|---|---|---|---|
| Expandable Graphite Content to 100 parts by mass of | | | 1.50 | 4.90 | — | 2.50 | 2.50 | — |
| Resin Component (parts by mass) | | | | | | | | |
| Phosphorous Content of Phosphorous-Containing Flame Retardant to 100 parts | | | 3.60 | 2.16 | 3.60 | — | 3.60 | 5.28 |
| by mass of Resin Component (parts by mass) | | | | | | | | |
| Mass Ratio of Nitrogen Content of Nitrogen-Containing Flame | | | 0.68 | 0.68 | 0.68 | — | — | 1.86 |
| Retardant to 100 parts by mass of Resin Component to | | | | | | | | |
| Phosphorus Content of Phosphorus-Containing Flame | | | | | | | | |
| Retardant to 100 parts by mass of Resin Component | | | | | | | | |
| (Nitrogen Content/Phosphorus Content) | | | | | | | | |
| Mass Ratio of Expandable Graphite Content to 100 parts by mass of Resin | | | 0.42 | 2.27 | — | — | 0.69 | — |
| Component to Phosphorus Content of Phosphorus-Containing | | | | | | | | |
| Flame Retardant to 100 parts by mass of Resin Component | | | | | | | | |
| (Expandable Graphite Content/Phosphorus Content) | | | | | | | | |
| Nitrogen Content of Nitrogen-Containing Flame Retardant to 100 parts | | | 2.45 | 1.47 | 2.45 | 4.90 | — | 9.80 |
| by mass of Resin Component (parts by mass) | | | | | | | | |
| Eval- | Heat Insulation Properties | Strength after Burning | ◯ | X | ◯ | X | ◯ | ◯ |
| uation | | Discoloration after Burning | X | ◯ | X | X | X | X |

| | | | | | | |
|---|---|---|---|---|---|---|
| Moldability | ◯ | ◯ | ◯ | ◯ | ◯ | X |
| Bending Strength (Mpa) | 276 | 278 | 277 | 278 | 278 | 256 |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### Industrial Application

The resin composition, the molding material, and the molded article of the present invention can be, for example, preferably used in production of battery cases.

1. A resin composition comprising:
a resin component, an aluminum hydroxide, expandable graphite, and a flame retardant, wherein
the flame retardant contains a phosphorus-containing flame retardant and a nitrogen-containing flame retardant;
the expandable graphite content is 1.0 part by mass or more and below 5.0 parts by mass with respect to 100 parts by mass of the resin component;
the phosphorus content of the phosphorus-containing flame retardant is 1.5 parts by mass or more and 4.5 parts by mass or less with respect to 100 parts by mass of the resin component;
a mass ratio of the nitrogen content of the nitrogen-containing flame retardant with respect to 100 parts by mass of the resin component to the phosphorus content of the phosphorus-containing flame retardant with respect to 100 parts by mass of the resin component is 0.5 or more and 3.0 or less; and
the mass ratio of the expandable graphite content with respect to 100 parts by mass of the resin component to the phosphorus content of the phosphorus-containing flame retardant with respect to 100 parts by mass of the resin component is 0.5 or more and 2.0 or less.

2. The resin composition according to claim 1, wherein
the nitrogen content of the nitrogen-containing flame retardant is 2.0 parts by mass or more and 3.0 parts by mass or less with respect to 100 parts by mass of the resin component.

3. A molding material comprising:
the resin composition according to claim 1 and a reinforcing fiber.

4. A molded article comprising:
a cured product of the molding material according to claim 3.
